(19) United States
(12) Patent Application Publication
(10) Pub. No.: US 2024/0351807 A1
(43) Pub. Date: Oct. 24, 2024

(54) RELAY TYPE DUMP TRUCK

(71) Applicant: Yantai Hengchi Trailer Co., Ltd., Yantai City (CN)

(72) Inventors: Dongwen WANG, Yantai City (CN); Zhangchao GUO, Yantai City (CN)

(73) Assignee: Yantai Hengchi Trailer Co., Ltd., Yantai City (CN)

(21) Appl. No.: 18/640,622

(22) Filed: Apr. 19, 2024

(30) Foreign Application Priority Data
Apr. 21, 2023 (CN) 202310430706.0

(51) Int. Cl. B65G 67/24

(52) U.S. Cl. CPC B65G 67/24

(57) ABSTRACT

Provided is a relay type dump truck including a bottom plate capable of moving backwards and retracting forwards in a reciprocating manner, and a front baffle positioned on the bottom plate and between a left side plate and a right side plate. Differences from the prior art are that: one side, side, close to a truck head, of the front baffle is provided with a backstop mechanism, and the backstop mechanism is free of combining, or establishing mutual attraction with the left side plate and the right side plate when the bottom plate moves backwards, and combines, or establishes mutual attraction with the left side plate and the right side plate when the bottom plate retracts forwards.

### CROSS-REFERENCE TO RELATED APPLICATION

This patent application claims the benefit and priority of Chinese Patent Application No. 202310430706.0 filed with the China National Intellectual Property Administration on Apr. 21, 2023, the disclosure of which is incorporated by reference herein in its entirety as part of the present application.

### TECHNICAL FIELD

The present disclosure relates to automatic dump trucks, and in particular to a relay type dump truck.

### BACKGROUND

Chinese Patent Application Publication No. 112026617B with a same inventor with the present applicant discloses an unloading device with a bottom plate capable of moving horizontally in a reciprocating mode and a follow-up front baffle, and a transport vehicle. The unloading device includes a frame, a bottom plate, a left side plate, a right side plate and a front baffle. The left side plate and the right side plate are fixedly connected to the frame, the frame supports the bottom plate in a rolling manner, and the bottom plate moves backwards and retracts forwards in a reciprocating manner. Elastic plates bent forwards are respectively fixed to both sides of the front baffle, and free ends of the elastic plates are respectively abutted against inner side surfaces of the left side plate and the right side plate. When the front baffle moves away from a vehicle head, i.e., moves backwards, a force direction of the elastic plate is consistent with a movement direction thereof, and the elastic plate contracts to the middle, at this time, the surface of the elastic plate is smooth, so that the front baffle can smoothly move forwards with the bottom plate. When the bottom plate retracts forwards, the force direction of the elastic plate is opposite to the movement direction thereof, and the elastic plates respectively expands to the left and right sides, at this time, the surface of the elastic plate is unsmooth, so that the front baffle can be locked on the left and right side plates and does not retract forwards with the bottom plate. In such a way, the goods can gradually fall out of the carriage to achieve the purpose of automatic unloading.

However, in practical application, especially in the case of the loaded goods have a large specific gravity or high viscosity, a phenomenon that the front baffle retracts forwards slowly or synchronously with the retraction of the bottom plate occurs when the bottom plate retracts forwards due to the fact that the locking force of the front baffle supported on the left and right side plates by means of the elastic plates is insufficient, resulting in poor unloading or failure to unload.

### SUMMARY

In order to overcome the technical defects or one of the technical defects in the prior art, the present disclosure provides a relay type dump truck, and an employed technical solution is as follows.

A relay type dump truck includes a bottom plate capable of moving backwards and retracting forwards in a reciprocating manner, and a front baffle positioned on the bottom plate and between a left side plate and a right side plate. Differences from the prior art are that: one side, side, close to a truck head, of the front baffle is provided with a backstop mechanism, and the backstop mechanism is free of combining, or establishing mutual attraction with the left side plate and the right side plate when the bottom plate moves backwards, and combines, or establishes mutual attraction with the left side plate and the right side plate when the bottom plate retracts forwards.

Furthermore, the backstop mechanism includes two lifting electromagnets, and each of the two lifting electromagnet is hinged to a front end of a connecting plate and an outer end of a telescopic rod; a rear end of the connecting plate is hinged to the front baffle, and an inner end of the telescopic rod penetrates into a sleeve; a stopper is fixedly arranged on a portion, outside the sleeve, of the telescopic rod, and a portion, between the stopper and an end face of the sleeve, of the telescopic rod is sleeved with a spring; and when the bottom plate retracts forwards, the two lifting electromagnets are energized to attract with the left side plate and the right side plate respectively, and when the bottom plate moves backwards, the two lifting electromagnets are powered off to abut against the left side plate and the right side plate respectively.

Furthermore, the backstop mechanism includes two friction plates, one of the two friction plates is hinged to a front end of one connecting plate and a piston rod of a backstop oil cylinder, and an other of the two friction plates is hinged to a front end of an other connecting plate and a cylinder body of the backstop oil cylinder; rear ends of foregoing two connecting plates are hinged to the front baffle; when the bottom plate retracts forwards, the piston rod of the backstop oil cylinder protrudes outwards, and the two friction plates are tightly abutted against the left side plate and the right side plate, respectively; and when the bottom plate moves backwards, the piston rod of the backstop oil cylinder retracts inwards, and the two friction plates are separated from the left side plate and the right side plate, respectively.

Furthermore, an extension rod is fixedly connected to the cylinder body of the backstop oil cylinder, and the other of the two friction plates is hinged to the cylinder body of the backstop oil cylinder through the extension rod.

Furthermore, each of the two friction plates includes a rubber plate capable of abutting against a corresponding one of the left side plate and the right side plate, and a support steel plate fixedly connected to the rubber plate.

Furthermore, one side, away from the truck head, of the front baffle is connected to a movable plate, a width of the movable plate is greater than a gap width between the front baffle and the left side plate or the right side plate, and the movable plate is configured for blocking the gap between the front baffle and the left side plate or the right side plate and scraping goods left on an inner surface of the left side plate or the right side plate.

Furthermore, a distance between an inner surface of the left side plate and an inner surface of the left side plate at a front end is smaller than that at a rear end.

Furthermore, a height of the bottom plate distancing from a ground at a front end is greater than that at a rear end.

Furthermore, a frame is fixedly provided with a plurality of rolling bearings, a shaft sleeve, a linear roller guide rail or a universal ball bearing, and a lower surface of the bottom plate is supported by the rolling bearings, an outer circular surface of the shaft sleeve or the linear roller guide rail, and an outer spherical surface of the universal ball bearing.

Furthermore, the frame is connected to cylinder bodies of more than one double-acting push-pull oil cylinder, and a piston rod of each double-acting push-pull oil cylinder is connected to the bottom plate.

Compared with the prior art, an active backstop mechanism is adopted to replace an elastic plate in the prior art, or the active backstop mechanism is added on the basis of the elastic plate, thus ensuring that the front baffle is free of retracting backwards with the bottom plate when the bottom plate retracts backwards, and the unloading is more rapid and thorough.

### BRIEF DESCRIPTION OF THE DRAWINGS

FIG. 1 is a structural schematic diagram of Embodiment 1 of the present disclosure;

FIG. 2 is an enlarged view of a partial structure of FIG. 1;

FIG. 3 is a structural schematic diagram of Embodiment 1 viewed in another direction;

FIG. 4 is an enlarged view of a partial structure of FIG. 3;

FIG. 5 is a structural schematic diagram of Embodiment 2 of the present disclosure;

FIG. 6 is an enlarged view of a partial structure of FIG. 5;

FIG. 7 is a structural schematic diagram of Embodiment 2 viewed in another direction;

FIG. 8 is an enlarged view of a partial structure of FIG. 7;

FIG. 9 is a structural schematic diagram of Embodiment 3 of the present disclosure;

FIG. 10 is an enlarged view of a partial structure of FIG. 9.

### DETAILED DESCRIPTION OF THE EMBODIMENTS

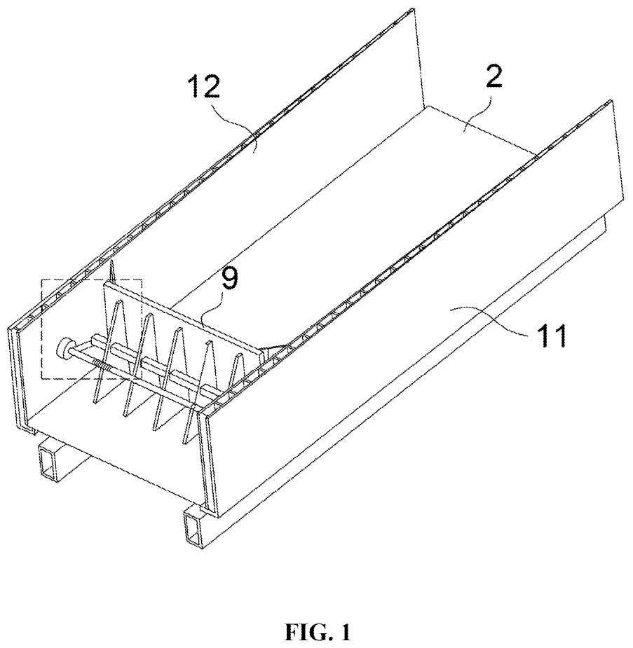

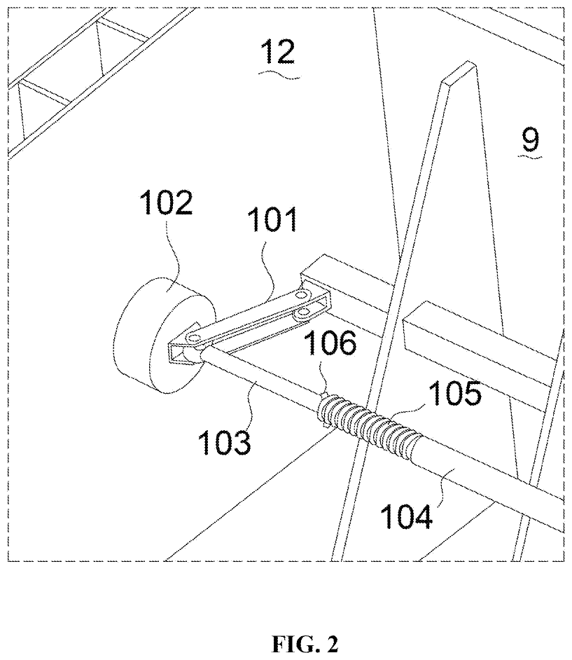

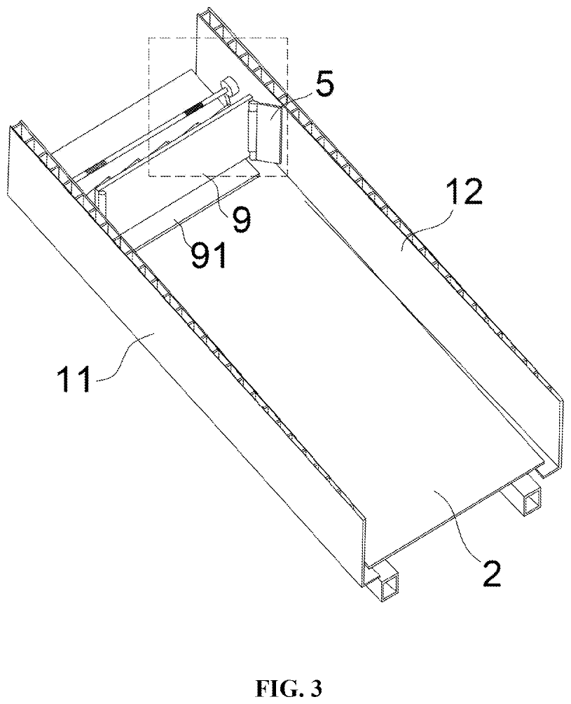

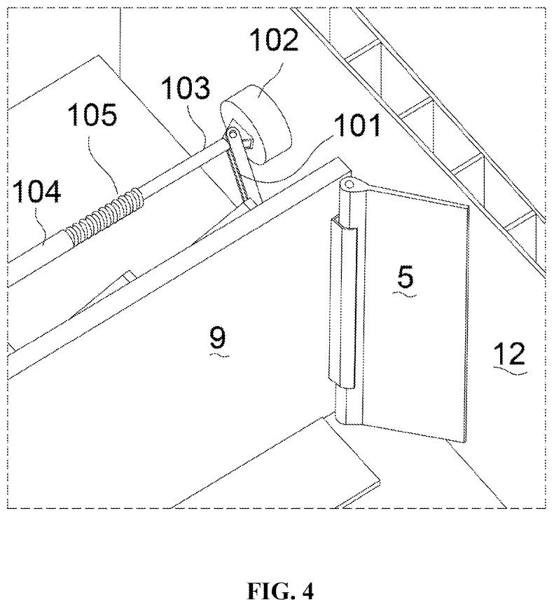

The present disclosure is further described below with reference to accompanying drawings.
Embodiment 1, please referring to FIG. 1 to FIG. 4.

A relay type dump truck includes a bottom plate 2 capable of moving backwards and retracting forwards in a reciprocating manner, and a front baffle 9 located on the bottom plate 2 and between a left side plate 11 and a right side plate 12. The left side plate 11 and the right side plate 12 are fixedly connected to a frame 1. One side, close to a truck head, of the front baffle 9 is provided with a backstop mechanism. The backstop mechanism includes two lifting electromagnets 102, and each lifting electromagnet 102 is hinged to a front end of a connecting plate 101 and an outer end of a telescopic rod 103. A rear end of the connecting plate 101 is hinged to the front baffle 9, and an inner end of the telescopic rod 103 penetrates into a sleeve 104. In another preferred embodiment, a stopper 106 is fixedly arranged on a portion, outside the sleeve 104, of the telescopic rod 103, and a portion, between the stopper 106 and an end surface of the sleeve 104, of the telescopic rod 103 is sleeved with a spring 105.

As a carriage is usually narrow at the front thereof and wide at the rear thereof, the lifting electromagnet 102 connected to the telescopic rod 103 can move left and right relative to the sleeve 104, thus adapting to the carriage which is narrow at the front thereof and wide at the rear thereof.

The springs 105 only play a role of making the lifting electromagnets 102 always close to or lightly abut against the left side plate 11 and the right side plate 12 respectively, which is convenient for the lifting electromagnets 102 to be magnetically attracted to the left side plate 11 and the right side plate 12 respectively without travel as required. In a case of no spring is provided, there may be a gap between the lifting electromagnet 102 and the left side plate 11 or the right side plate 12, and the lifting electromagnets 102 may respectively collide with the left side plate 11 and the right side plate 12 heavily under the huge magnetic force after being electrified, which may deform the left side plate 11 and the right side plate 12 or break the lifting electromagnets 102. Thus, the function of the springs are not to provide a pressing force, the principle and purpose of the springs of the present disclosure is different from that of the elastic plates and the springs thereon in the prior art. The elastic plates in the prior art are not the backstop mechanism in Embodiment 1. The backstop mechanism according to the present disclosure works intermittently, that is, when the bottom plate moves backwards, the backstop mechanism is free of combining, or establishing mutual attraction with the left side plate and the right side plate, and when the bottom plate retracts forwards, the backstop mechanism combines, or establishes mutual attraction with the left side plate and the right side plate. However, the elastic plates in the prior art are always abutted against the left side plate and the right side plate respectively to establish abutting forces.

During unloading goods, a rear baffle is turned upwards and opened, and a part of the goods located on the bottom plate 2 naturally collapses and falls, and the remaining part of the goods are stacked on the bottom plate 2 in a slope shape. At this time, the two lifting electromagnets 102 are in a power-off state and respectively abut against the left side plate 11 and the right side plate 12 under the elastic forces of the springs. Then, the bottom plate 2 is translated by a distance, such as 50 cm, in a direction away from the truck head. As there are goods stacked on a drag plate 91, and the drag plate 91 is connected to the front baffle 9, a pulling force is formed on the drag plate when the goods are translated with the bottom plate 2. Moreover, as the two lifting electromagnets 102 abut against the left side plate 11 and the right side plate 12 respectively only under the elastic forces of the springs, the friction forces of the two lifting electromagnets 102 are small and can be ignored, the front baffle 9 can also be translated with the bottom plate accordingly. At this time, although the goods are still on the bottom plate, the goods within 50 cm from the rear end of the bottom plate are located outside the carriage.

Then, the bottom plate 2 retracts forwards and the two lifting electromagnets 102 are energized simultaneously. Due to the fact that the left side plate 11 and the right side plate 12 are both steel plates, the two lifting electromagnets 102 are respectively attracted with the left side plate 11 and the right side plate 12. The lifting electromagnet is mature commodities, and has the lifting capacity up to several tons to dozens of tons. When the bottom plate 2 is retracted forwards, the front baffle 9 can be prevented from translating towards the truck head with the bottom plate 2, and the goods thus are prevented from translating towards the truck head by the front baffle 9, resulting in a situation that the goods within 50 cm from the rear end of the bottom plate are not supported by the bottom plate 2 and fall out of the carriage. After the forward retraction of the bottom plate 2 is finished, the two lifting electromagnets 102 are restored to the power-off state.

When the bottom plate 2 is translated by 50 cm in a direction away from the truck head again, the goods within 50 cm from the rear end of the bottom plate are again placed on the bottom plate outside the carriage. When the bottom plate 2 retracts forwards, this goods are unloaded again. In this way, the front baffle 9 is getting closer and closer to the rear end of the carriage, and the goods are gradually unloaded out of the carriage, and finally all the goods on the bottom plate 2 are unloaded.

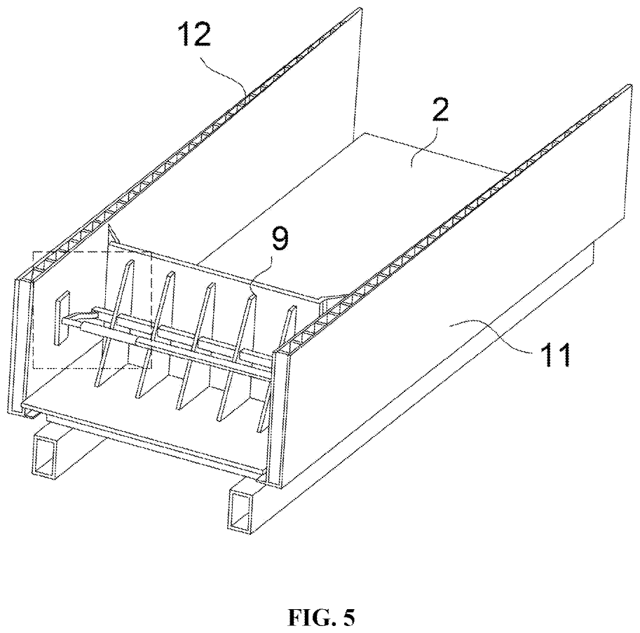

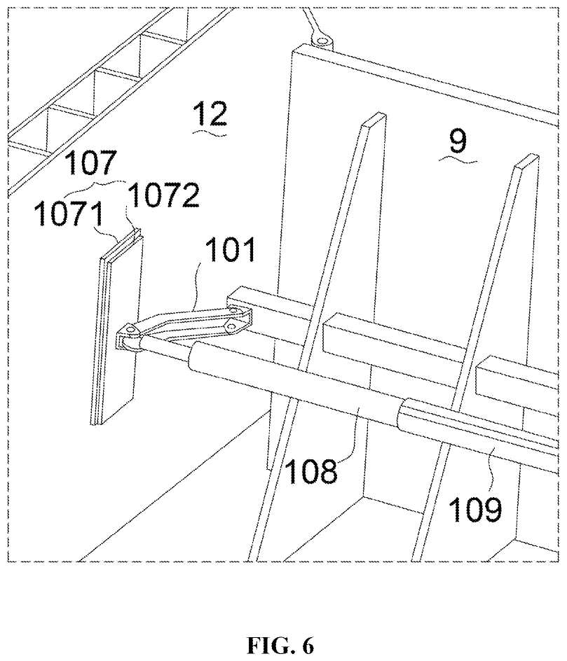

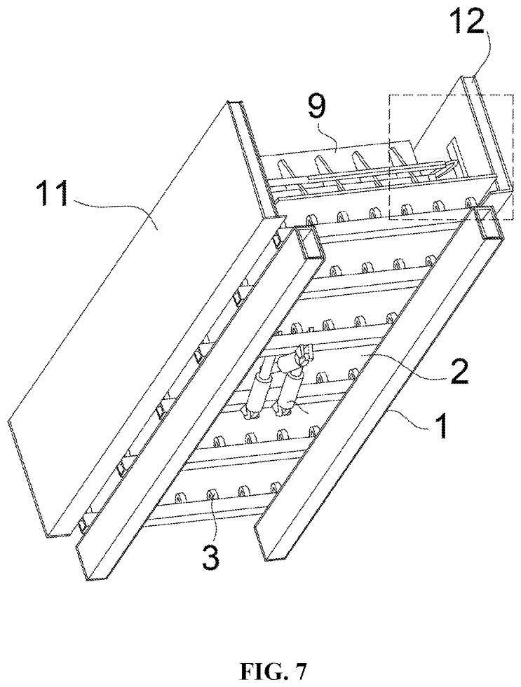

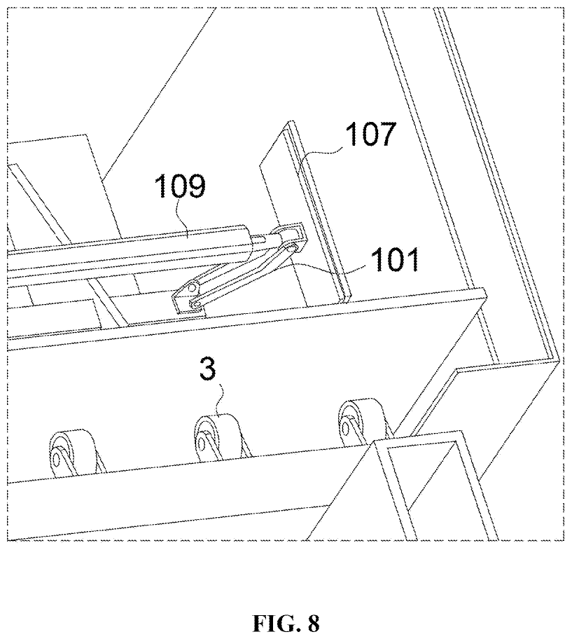

After unloading of all the goods is finished, a pulling rope (not shown in the figure) is pulled by a device such as a winch arranged in front of the carriage, and the front baffle is dragged back to the front end of the carriage near the truck head for resetting.
Embodiment 2, please referring to FIG. 5 to FIG. 8.

Another relay type dump track includes a bottom plate 2 capable of moving backwards and retracting forwards in a reciprocating manner, and a front baffle 9 located on the bottom plate 2 and between a left side plate 11 and a right side plate 12. The left side plate 11 and the right side plate 12 are fixedly connected to a frame 1. One side, close to a truck head, of the front baffle 9 is provided with a backstop mechanism. The backstop mechanism includes two friction plates 107, one of the two friction plates 107 is hinged to a front end of one of two connecting plates 101 and a piston rod of a backstop oil cylinder 108, and the other of the two friction plates 107 is hinged to a front end of the other of the two connecting plates 101 and a cylinder body of the backstop oil cylinder 108. Rear ends of the two connecting plates 101 are hinged with the front baffle 9. When the bottom plate 2 retracts forwards, the piston rod of the backstop oil cylinder 108 protrudes outwards, and the two friction plates 107 are tightly abutted against the left side plate 11 and the right side plate 12, respectively. When the bottom plate 2 moves backwards, the piston rod of the backstop oil cylinder 108 retracts inwards, and the two friction plates 107 are separated from the left side plate 11 and the right side plate 12, respectively. An extension rod 109 is fixedly connected to the cylinder body of the backstop oil cylinder 108, and the other of the two friction plate 107 is hinged to the cylinder body of the backstop oil cylinder 108 through the extension rod 109. Each of the two friction plate 107 includes a rubber plate 1071 capable of abutting against a corresponding one of the left side plate 11 and the right side plate 12, and a support steel plate 1072 fixedly connected to the rubber plate 1071. The backstop oil cylinder 108 is supported in a floating state by means of the two connecting plates 101 on both sides thereof, and both ends of the backstop oil cylinder 108 are hinged, thus a direction of force applied by the piston rod of the backstop oil cylinder 108 is always consistent with an axial direction of the piston rod, and the problem that the piston rod is bent under pushing can be avoided. The two connecting plates are hinged to the two friction plates 107 respectively, the friction resistances between the two friction plates 107 and the left side plate 11 and the right side plate 12 are directly transferred to the front baffle 9 through the two connecting plates, but not transferred to the piston rod, thus the problem that the piston rod is bent under pushing can be avoided. The rubber plate 1071 has a certain elasticity and high friction coefficient, and can be in full contact with the left side plate 11 or the right side plate 12 once being pressed, thus increasing the friction force. Moreover, the rubber plate 1071, when being pressed, can squeeze out the air between the rubber plate 1071 and the left side plate 11 or the right side plate 12 to form a vacuum, thus the external atmospheric pressure will also increase a bonding force between the friction plate 107 and the left side plate 11 or the right side plate 12.

During unloading goods, a rear baffle is turned upwards and opened, and a part of the goods located on the bottom plate 2 naturally collapses and falls, and the remaining part of the goods are stacked on the bottom plate 2 in a slope shape. At this time, the backstop oil cylinder 108 is in the return stroke, and the two friction plates 107 are free of making contact with the left side plate 11 and the right side plate 12 respectively. Then, the bottom plate 2 is translated by a distance, such as 50 cm, in a direction away from the truck head. As there are goods stacked on a drag plate 91, and the drag plate 91 is connected to the front baffle 9, a pulling force is formed on the drag plate when the goods are translated with the bottom plate 2. Moreover, as the two friction plates 107 are free of making contact with the left side plate 11 and the right side plate 12 respectively, there is no friction force between them, and the front baffle 9 can also be translated with the bottom plate accordingly. At this time, although the goods are still on the bottom plate, the goods within 50 cm from the rear end of the bottom plate are located outside the carriage.

Then, the bottom plate 2 retracts forwards and the piston rod of the backstop oil cylinder 108 protrudes outwards to promote the two friction plates 107 to be tightly abutted against the left side plate 11 and the right side plate 12 respectively, thus preventing the front baffle 9 from translating towards the truck head with the bottom plate 2. The goods are prevented by the front baffle 9 from translating towards the truck head, resulting in a situation that the goods within 50 cm from the rear end of the bottom plate are not supported by the bottom plate 2 and fall out of the carriage. After the forward retraction of the bottom plate 2 is finished, the backstop oil cylinder 108 returns back, and the two friction plates 17, the left side plate 11 and the right side plate 12 are restored to a separated state.

When the bottom plate 2 is translated by 50 cm in a direction away from the truck head again, the goods within 50 cm from the rear end of the bottom plate are again placed on the bottom plate outside the carriage. When the bottom plate 2 is retracted forwards again, this goods are unloaded again. In this way, the front baffle 9 is getting closer and closer to the rear end of the carriage, and the goods are gradually unloaded out of the carriage, and finally all the goods on the bottom plate 2 are unloaded.

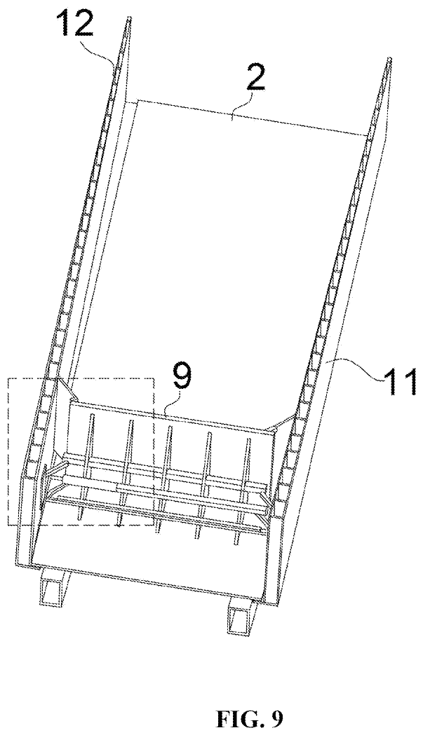

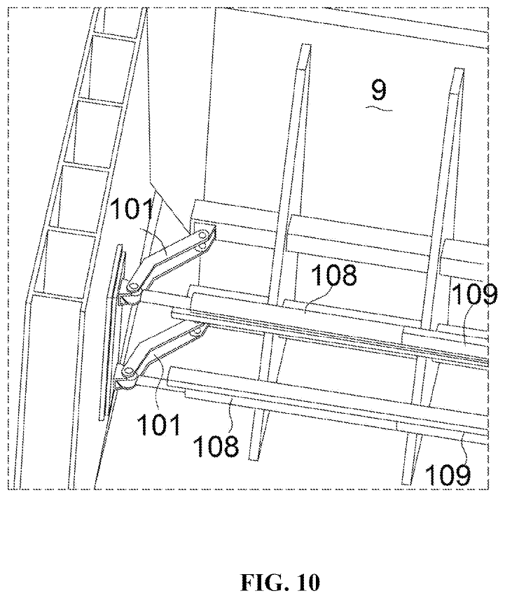

After unloading of all the goods is finished, a pulling rope (not shown in the figure) is pulled by a device such as a winch arranged in front of the carriage, and the front baffle is dragged back to the front end of the carriage near the truck head for resetting.
Embodiment 3, please referring to FIG. 5 to FIG. 10.

On the basis of Embodiment 2, two sets of backstop mechanisms sharing a set of friction plates are added. Therefore, the friction forces between the friction plates and the left side plate 11 and the right side plate 12 is further increased to improve the backstop effect.

In another preferred embodiment, movable plates 5 are connected to one side, away from the truck head, of the front baffle 9, the movable plate 5, if being an elastic plate, can be fixedly connected to the front baffle 9; and the movable plate 5, if being a hard plate, can be hinged to the front baffle 9. A width of the movable plate 5 is greater than that of a gap between the front baffle 9 and the left side plate 11 or the right side plate 12, and the movable plates 5 are suitable for blocking gaps between the front baffle 9 and the left side plate 11 and between the front baffles 9 and the right side plate 12 and scraping goods left on an inner surface of the left side plate 11 and the right side plate 12.

In another preferred embodiment, a distance between the inner surface of the left side plate 11 and the inner surface of the left side plate 12 at a front end is smaller than that at a rear end, thus the carriage is narrow at front and wide at rear. When the goods move backwards relative to the left side plate 11 and the right side plate 12 of the carriage, a passage between the left side plate 11 and the right side plate 12 becomes wider and wider, and no jam will occur.

In another preferred embodiment, a height of the bottom plate 2 distancing from the ground at the front end is greater than that at the rear end, thus the carriage is high at front and low at rear. The backward movement of the goods relative to the left side plate 11 and the right side plate 12 of the carriage is more energy-saving, and the higher the inclination of the bottom plate, the more the labor-saving. In an extreme case, when an inclination angle is greater than a limit angle or stable angle of the natural collapse of the goods, the goods can be unloaded under the own gravity thereof. Certainly, this is not desirable on transporting vehicles, which may result in a small cargo capacity. In practice, a better balance point will be found, such as 5-8 degrees.

In another preferred embodiment, a frame 1 is fixedly provided with multiple rolling bearings 3, a shaft sleeve, a linear roller guide rail, or a universal ball bearing, and a lower surface of the bottom plate 2 is supported by the rolling bearings, an outer circular surface of the shaft sleeve or the linear roller guide rail, and an outer spherical surface of the universal ball bearing. The frame 1 is connected to cylinder bodies of more than one double-acting push-pull oil cylinder 4, and a piston rod of each double-acting push-pull oil cylinder 4 is connected to the bottom plate 2. The double-acting push-pull oil cylinder 4 can achieve the reciprocating translation of the bottom plate 2.

According to the above principles, the above specific embodiments can be appropriately changed and modified by the present disclosure. Therefore, the present disclosure is not limited to the specific embodiments disclosed and described above, and some modifications and changes to the present disclosure should also fall within the scope of protection of the claims of the present disclosure. In addition, although some specific terms are used in this specification, these terms are only for the convenience of description and do not constitute any limitation on the present disclosure.

What is claimed is:

1. A relay type dump truck, comprising a bottom plate capable of moving backwards and retracting forwards in a reciprocating manner, and a front baffle positioned on the bottom plate and between a left side plate and a right side plate, wherein one side, close to a truck head, of the front baffle is provided with a backstop mechanism, and the backstop mechanism is free of combining, or establishing mutual attraction with the left side plate and the right side plate when the bottom plate moves backwards, and combines, or establishes mutual attraction with the left side plate and the right side plate when the bottom plate retracts forwards.

2. The relay type dump truck according to claim 1, wherein the backstop mechanism comprises two lifting electromagnets, and each of the two lifting electromagnet is hinged to a front end of a connecting plate and an outer end of a telescopic rod; a rear end of the connecting plate is hinged to the front baffle, and an inner end of the telescopic rod penetrates into a sleeve; and when the bottom plate retracts forwards, the two lifting electromagnets are energized to attract with the left side plate and the right side plate respectively, and when the bottom plate moves backwards, the two lifting electromagnets are powered off to abut against the left side plate and the right side plate respectively.

3. The relay type dump truck according to claim 2, wherein a stopper is fixedly arranged on a portion, outside the sleeve, of the telescopic rod, and a portion, between the stopper and an end face of the sleeve, of the telescopic rod is sleeved with a spring.

4. The relay type dump truck according to claim 1, wherein the backstop mechanism comprises two friction plates, one of the two friction plates is hinged to a front end of one connecting plate and a piston rod of a backstop oil cylinder, and an other of the two friction plates is hinged to a front end of an other connecting plate and a cylinder body of the backstop oil cylinder; rear ends of foregoing two connecting plates are hinged to the front baffle; when the bottom plate retracts forwards, the piston rod of the backstop oil cylinder protrudes outwards, and the two friction plates are tightly abutted against the left side plate and the right side plate, respectively; and when the bottom plate moves backwards, the piston rod of the backstop oil cylinder retracts inwards, and the two friction plates are separated from the left side plate and the right side plate, respectively.

5. The relay type dump truck according to claim 4, wherein an extension rod is fixedly connected to the cylinder body of the backstop oil cylinder, and the other of the two friction plates is hinged to the cylinder body of the backstop oil cylinder through the extension rod.

6. The relay type dump truck according to claim 4, wherein each of the two friction plates comprises a rubber plate capable of abutting against a corresponding one of the left side plate and the right side plate, and a support steel plate fixedly connected to the rubber plate.

7. The relay type dump truck according to claim 1, wherein one side, away from the truck head, of the front baffle is connected to a movable plate, a width of the movable plate is greater than a gap width between the front baffle and the left side plate or the right side plate, and the movable plate is configured for blocking the gap between the front baffle and the left side plate or the right side plate and scraping goods left on an inner surface of the left side plate or the right side plate.

8. The relay type dump truck according to claim 1, wherein a distance between an inner surface of the left side plate and an inner surface of the left side plate at a front end is smaller than that at a rear end.

9. The relay type dump truck according to claim 1, wherein a height of the bottom plate distancing from a ground at a front end is greater than that at a rear end.

10. The relay type dump truck according to claim 1, wherein a frame is fixedly provided with a plurality of rolling bearings, a shaft sleeve, a linear roller guide rail or a universal ball bearing, and a lower surface of the bottom plate is supported by the rolling bearings, an outer circular surface of the shaft sleeve or the linear roller guide rail, and an outer spherical surface of the universal ball bearing; and the frame is connected to cylinder bodies of more than one double-acting push-pull oil cylinder, and a piston rod of each double-acting push-pull oil cylinder is connected to the bottom plate.

11. The relay type dump truck according to claim 7, wherein the backstop mechanism comprises two lifting electromagnets, and each of the two lifting electromagnet is hinged to a front end of a connecting plate and an outer end of a telescopic rod; a rear end of the connecting plate is hinged to the front baffle, and an inner end of the telescopic rod penetrates into a sleeve; and when the bottom plate retracts forwards, the two lifting electromagnets are energized to attract with the left side plate and the right side plate respectively, and when the bottom plate moves backwards, the two lifting electromagnets are powered off to abut against the left side plate and the right side plate respectively.

12. The relay type dump truck according to claim 11, wherein a stopper is fixedly arranged on a portion, outside the sleeve, of the telescopic rod, and a portion, between the stopper and an end face of the sleeve, of the telescopic rod is sleeved with a spring.

13. The relay type dump truck according to claim 7, wherein the backstop mechanism comprises two friction plates, one of the two friction plates is hinged to a front end of one connecting plate and a piston rod of a backstop oil cylinder, and an other of the two friction plates is hinged to a front end of an other connecting plate and a cylinder body of the backstop oil cylinder; rear ends of foregoing two connecting plates are hinged to the front baffle; when the bottom plate retracts forwards, the piston rod of the backstop oil cylinder protrudes outwards, and the two friction plates are tightly abutted against the left side plate and the right side plate, respectively; and when the bottom plate moves backwards, the piston rod of the backstop oil cylinder retracts inwards, and the two friction plates are separated from the left side plate and the right side plate, respectively.

14. The relay type dump truck according to claim 13, wherein an extension rod is fixedly connected to the cylinder body of the backstop oil cylinder, and the other of the two friction plates is hinged to the cylinder body of the backstop oil cylinder through the extension rod.

15. The relay type dump truck according to claim 13, wherein each of the two friction plates comprises a rubber plate capable of abutting against a corresponding one of the left side plate and the right side plate, and a support steel plate fixedly connected to the rubber plate.

16. The relay type dump truck according to claim 8, wherein the backstop mechanism comprises two lifting electromagnets, and each of the two lifting electromagnet is hinged to a front end of a connecting plate and an outer end of a telescopic rod; a rear end of the connecting plate is hinged to the front baffle, and an inner end of the telescopic rod penetrates into a sleeve; and when the bottom plate retracts forwards, the two lifting electromagnets are energized to attract with the left side plate and the right side plate respectively, and when the bottom plate moves backwards, the two lifting electromagnets are powered off to abut against the left side plate and the right side plate respectively.

17. The relay type dump truck according to claim 16, wherein a stopper is fixedly arranged on a portion, outside the sleeve, of the telescopic rod, and a portion, between the stopper and an end face of the sleeve, of the telescopic rod is sleeved with a spring.

18. The relay type dump truck according to claim 8, wherein the backstop mechanism comprises two friction plates, one of the two friction plates is hinged to a front end of one connecting plate and a piston rod of a backstop oil cylinder, and an other of the two friction plates is hinged to a front end of an other connecting plate and a cylinder body of the backstop oil cylinder; rear ends of foregoing two connecting plates are hinged to the front baffle; when the bottom plate retracts forwards, the piston rod of the backstop oil cylinder protrudes outwards, and the two friction plates are tightly abutted against the left side plate and the right side plate, respectively; and when the bottom plate moves backwards, the piston rod of the backstop oil cylinder retracts inwards, and the two friction plates are separated from the left side plate and the right side plate, respectively.

19. The relay type dump truck according to claim 18, wherein an extension rod is fixedly connected to the cylinder body of the backstop oil cylinder, and the other of the two friction plates is hinged to the cylinder body of the backstop oil cylinder through the extension rod.

20. The relay type dump truck according to claim 18, wherein each of the two friction plates comprises a rubber plate capable of abutting against a corresponding one of the left side plate and the right side plate, and a support steel plate fixedly connected to the rubber plate.
